(19) United States
(12) Patent Application Publication
(10) Pub. No.: US 2004/0081756 A1
(43) Pub. Date: Apr. 29, 2004

(54) Workpiece coating apparatus

(76) Inventors: Timothy D. Coots, Davison, MI (US); Will Stephau, Flint, MI (US)

Correspondence Address: Eric T Jones, Reising Ethington Barnes Kisselle, Learman & McCulloch, PO Box 4390, Troy, MI, 48099-4390, US

(21) Appl. No.: 10/433,497

(22) PCT Filed: Dec. 3, 2001
(86) PCT No.: PCT/US01/45823

(51) Int. Cl. B05D 3/02; B05D 3/12; B05C 13/00

(52) U.S. Cl. 427/240; 427/372.2; 118/58; 118/64; 118/65

(57) ABSTRACT

A workpiece coating apparatus (12) for applying a coating to each of a plurality of workpieces (11). A coating system (14) includes a coating chamber (18) that receives the workpieces (11) for coating. A curing system (16) includes a curing chamber (20) that receives workpieces (11) for curing. A conveyor system (22) rotates the workpieces (11) about horizontal axes (38) while serially transporting them first through the coating chamber (18) for coating and then through the curing chamber (20) for curing. The coating chamber (18) and curing chamber (20) are stacked to minimize floor space requirements.

### BACKGROUND OF THE INVENTION

1. Field of the Invention

This invention relates generally to a workpiece coating apparatus for applying a coating to each of a plurality of workpieces.

2. Description of the Related Art

It is known for coating systems to include washers and dryers that wash, rinse and dry workpieces (such as automotive trim substrates) before applying one or more coatings to the workpieces. A coating system washer of this type will generally include washing and rinsing chambers that the substrates pass through as they're washed and rinsed and a drying chamber that the substrates pass through for drying after they've been washed and rinsed. A coating system applies coatings to the substrates in one or more coating chambers after they've been washed, rinsed and dried. After coating, curing systems promote or facilitate curing of the newly applied coatings in curing chambers that employ convection or radiant heaters. Some workpiece coating systems are known to use conveyors that rotate the substrates about a vertical axis while serially transporting them through the washing, drying, coating and curing chambers. However, coating systems take up a considerable amount of floorspace for the amount of throughput they're able to generate. Also, coating thickness must be carefully limited to prevent runs and other coating thickness irregularities that typically result from the effects of gravity on the coating when it has just been applied to a substrate and is still uncured.

What is needed is a workpiece coating apparatus that requires less floor space for a given amount of throughput, provides for more uniform coating thicknesses across the surfaces of each workpiece, and the ability to apply thicker coatings without runs or sags.

### BRIEF SUMMARY OF THE INVENTION

The invention is a workpiece coating apparatus for applying coatings to workpieces. The apparatus includes a coating system configured to coat workpieces and including a coating chamber configured to receive workpieces for coating. The apparatus also includes a curing system configured to cure coatings that the coating system has applied to workpieces. The curing system includes a curing chamber configured to receive workpieces for curing. The workpiece coating apparatus also includes a conveyor configured to serially transport workpieces first through the coating chamber and then through the curing chamber.

Unlike the prior art of record, the coating chamber and curing chamber of a coating apparatus constructed according to the invention are disposed in a stacked arrangement to minimize floor space requirements. A plurality of such coating apparatuses can thus be employed to increase throughput while enhancing manufacturing flexibility. Flexibility is enhanced because a coating apparatus constructed according to the invention can be easily integrated into manufacturing operations that produce workpieces to be coated and/or manufacturing operations the apparatus is coating workpieces for. Additionally, each coating apparatus can be configured differently to handle different workpieces or to apply different coatings. The use of multiple coating systems can also minimize the impact of downtime for maintenance, repair or reconfiguration. This is because other units can continue operating while one coating apparatus at a time is shut down.

According to another aspect of the invention, the conveyor is configured to rotate the workpieces about horizontal axes while transporting the workpieces serially through at least one of the coating module and the curing module. Rotation of the workpieces about horizontal axes effectively neutralizes the effects of gravity on uncured coatings, preventing runs and sags, providing greater coating thickness uniformity and allowing for thicker coatings.

The invention also includes a method for applying a coating to each of a plurality of workpieces using a coating apparatus comprising a coating system configured to coat workpieces and a curing system configured to cure workpieces, the coating system including a coating chamber configured to receive workpieces for coating, the curing system including a curing chamber configured to receive workpieces for curing, and the coating chamber and curing chamber disposed in a stacked arrangement. According to this method one can apply a coating to each of a plurality of workpieces by transporting each workpiece along a vertically oriented circuit such that each workpiece passes first through the coating chamber and then through the curing chamber. A coating is deposited on each workpiece as it passes through the coating chamber. Each workpiece is rotated about a horizontal axis as the coating is deposited on the workpiece.

### BRIEF DESCRIPTION OF THE SEVERAL VIEWS OF THE DRAWINGS

These and other features and advantages of the invention will become apparent to those skilled in the art in connection with the following detailed description and drawings, in which:

FIG. 1 is a schematic front view of a coating apparatus constructed according to the invention;

FIG. 2 is a schematic cross-sectional side view to the coating apparatus of FIG. 1 taken along line 2-2 of FIG. 1;

FIG. 3 is a schematic front view of a washing/drying module of the coating apparatus of FIG. 1;

FIG. 4 is a magnified schematic view of rinsing stages of the washing/drying module of FIG. 3;

FIG. 5 is a schematic block diagram depicting air distribution within the coating apparatus of FIG. 1;

FIG. 6 is a magnified side view of conveyor components of the coating apparatus of FIG. 1 showing a hub-mounted sprocket of the conveyor engaging a dynamic rotator chain of the conveyor;

FIG. 7 is a magnified side view of conveyor components of the coating apparatus of FIG. 1 showing a hub-mounted sprocket of the conveyor engaging a static rotator chain of the conveyor;

FIG. 8 is a magnified front view of conveyor components of the coating apparatus of FIG. 1 showing a hub-mounted sprocket of the conveyor engaging a static rotator chain of the conveyor;

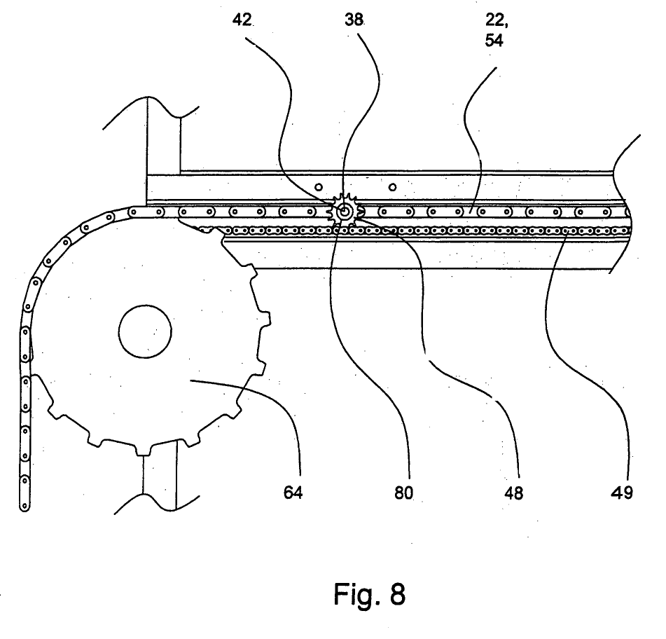

FIG. 9 is a schematic diagram depicting coating fluid distribution with the coating apparatus of FIG. 1; and

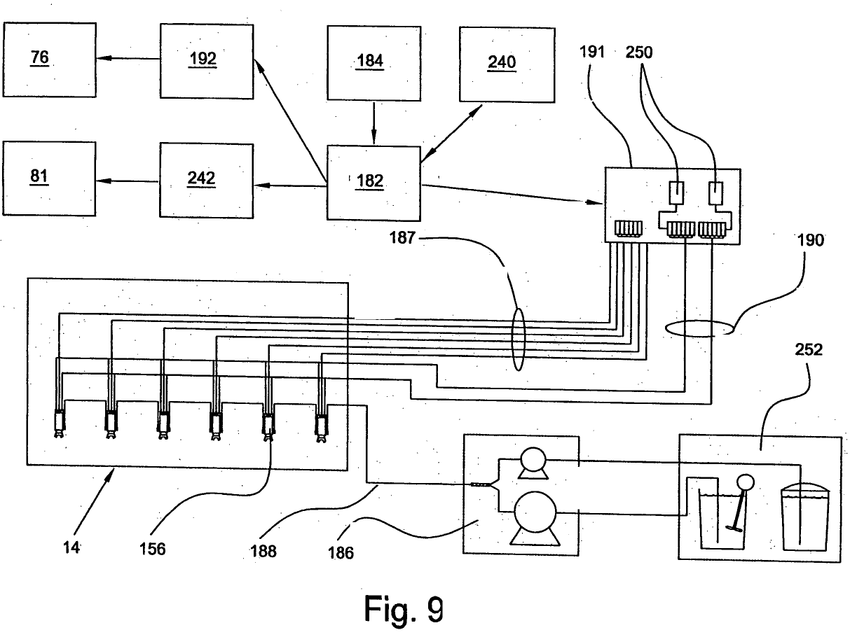

FIG. 10 is a magnified cross-sectional view of an interface between curing and coating modules of the coating apparatus of FIG. 1.; and

FIG. 11 is a magnified cross-sectional view of an interface between coating and washing/drying modules of the coating apparatus of FIG. 1.

### DESCRIPTION OF INVENTION EMBODIMENT(S)

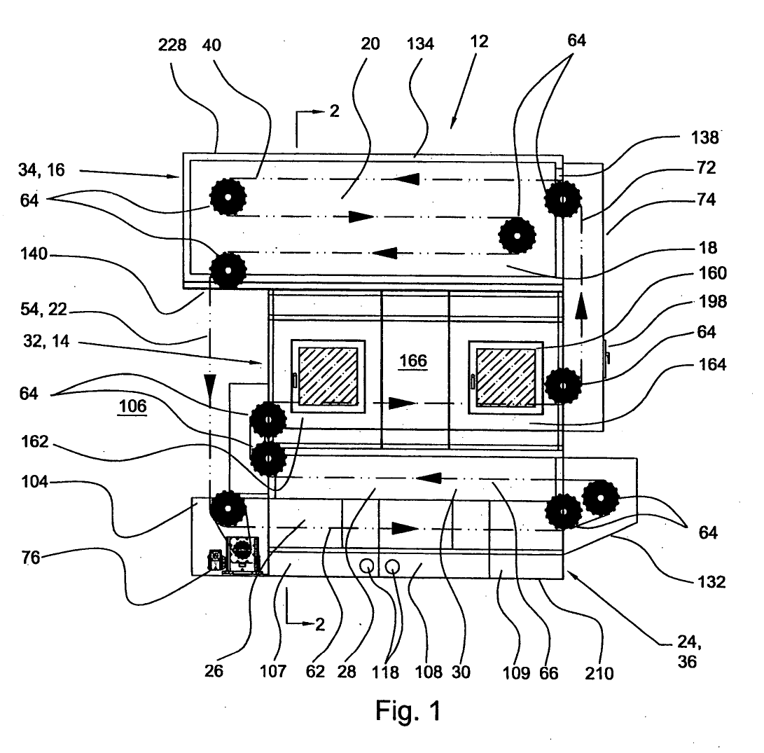

A workpiece coating apparatus for applying a coating to each of a plurality of workpieces 11 is shown in the drawings at 12. As shown in FIG. 1 and as most broadly described, the apparatus 12 includes a coating system 14 that coats workpieces 11 and a curing system 16 that cures the coating or coatings that the coating system 14 has applied to workpieces 11. The coating system 14 includes a coating chamber 18 that receives workpieces 11 for coating and the curing system 16 includes a curing chamber 20 configured to receive workpieces 11 for curing. The apparatus 12 also includes a conveyor system 22 that serially transport workpieces 11 first through the coating chamber 18 and then through the curing chamber 20. The coating chamber 18 and curing chamber 20 are disposed in a stacked arrangement.

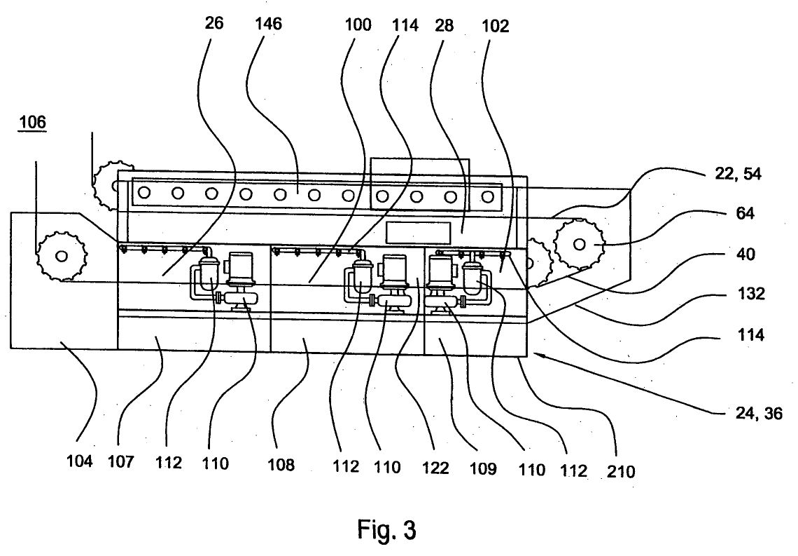

As best shown in FIG. 3, the coating apparatus 12 also includes a washer 24 that washes and rinses workpieces 11. The washer 24 includes a wash chamber 26 that the workpieces 11 pass through as they're washed and a drier 28 that dries workpieces 11 after they've been washed and rinsed. The drier 28 includes a drying chamber 30 that the workpieces 11 pass through as they're dried. The conveyor system 22 serially transports workpieces 11 first through the wash chamber 26, then through the drying chamber 30 and then through the coating chamber 18 and the curing chamber 20.

The wash chamber 26 and drying chamber 30 are disposed in a stacked arrangement along with the coating chamber 18 and the curing chamber 20. The curing chamber 20 is disposed above the coating chamber 18, the coating chamber 18 is disposed above the wash chamber 26 and the drying chamber 30, and the drying chamber 30 is disposed above the wash chamber 26.

The coating apparatus 12 includes a coating module 32 that includes the coating chamber 18. The coating apparatus 12 also includes a curing module 34 that includes the curing chamber 20. The curing module 34 is removably attached to the coating module 32. Similarly, the coating apparatus 12 includes a washing/drying module 36 that comprises the wash chamber 26 and the drying chamber 30. The coating module 32 is removably attached to the washing/drying module 36.

The conveyor system 22 rotates the workpieces 11 about horizontal axes 38 while transporting the workpieces 11 serially through the coating module 32 and the curing module 34. The conveyor system 22 includes a conveyor chain loop 40 that is routed sequentially through the coating module 32 and the curing module 34. A plurality of workpiece racks 42 are supported for rotation about respective horizontal rotational axes 38 that extend perpendicularly from the conveyor chain 40. The racks 42 are supported at spaced locations along the conveyor chain 40 with each rack 42 including one or more workpiece mounts 44 configured to removably support one or more workpieces 11. Each workpiece rack 42 includes an elongated stem 46 that horizontally spaces the workpiece mounts 44 from the conveyor chain 40 along the horizontal rotational axis 38 of the rack 42.

The conveyor system 22 includes hub-mounted sprockets 48 that are coaxially fixed to each respective workpiece rack 42. The conveyor system 22 also includes lengths of static rotator chain 49, 50, 51 mounted in positions to engage the hub-mounted sprockets 48 and to cause the hub-mounted sprockets 48 and attached workpiece racks 42 to rotate about their respective horizontal rotational axes 38.

The conveyor system 22 further includes a dynamic continuous rotator chain loop 52 that's supported to be driven around a defined circuit 60 and in a position to engage the hub-mounted sprockets 48 supporting the workpiece mounting racks 42 on the conveyor chain 40 as the conveyor chain 40 carries the racks 42 along the conveyor chain circuit 60 such that the sprockets 48 mesh with the dynamic rotator chain 52 and rotate the mounting racks 42 about the horizontal rotational axis of the workpiece-mounting rack 42. The dynamic rotator chain 52 allows each mounting rack 42 and workpieces 11 carried by the racks 42 to be rotated at a controlled adjustable rotational speed.

A more detailed description of the preferred embodiment follows:

The coating apparatus 12 has an overall generally rectangular shape and is primarily of metallic construction. In the present embodiment the modules 32, 34, 36 are stacked directly on top of one another with the washing/drying module 36 supported on a support surface, the coating module 32 supported on the washing/drying module 36 and the curing module 34 supported on the coating module 32. However, in other embodiments the modules 32, 34, 36 may be supported in their stacked disposition by any other means known in the art to include an external framework or suspension apparatus 12 connected to an overhead support member such as a ceiling. As such, the word “stacked”, as used herein, is intended to broadly describe a generally vertical relative orientation. As used herein, the word “stacked” may variously describe modules 32, 34, 36 that are supported on top of each other, are supported by external means and/or are vertically spaced from one another.

The conveyor system 22 includes three chain-driven systems: a conveyor system 54, a dynamic rotator system 56 and a static rotator system 58. The conveyor system 54 includes the continuous conveyor chain loop 40 that is routed sequentially through each of the three modules 32, 34, 36, and traverses the three modules via the vertically oriented circuit 60. The conveyor chain 40 travels along a horizontal portion 62 of the circuit 60 through washing and rinsing stages of the washing/drying module 36, turns upward 180° around a series of main drive sprockets 64, then travels along a second horizontal portion 66 of the circuit 60 through a drying chamber 30 of the washing/drying module 36 in a direction parallel to and opposite its direction of travel through the washer 24. At the end of the drying chamber 30, the conveyor chain 40 again turns upward 180° around a series of sprockets 64, then travels along a third horizontal portion 70 of the circuit 60 through the coating module 32 in a direction parallel to and opposite its direction of travel through the drying chamber 30 of the washing/drying module 36. At the end of the coating module 32, the conveyor chain 40 turns upward 90° along a vertical portion 72 of the circuit 60 through an elongated, box-shaped vertically oriented final flash enclosure 74 or tunnel. At an upper end of the final flash enclosure 74, the conveyor chain 40 turns 90° and enters an entry end of the curing module 34 in a horizontal direction parallel to and opposite its direction of travel through the coating module 32. The conveyor chain 40 then travels through the curing module 34 with a series of downward 180° serpentine turns before exiting at the bottom of the curing module 34 at an exit end of the curing module 34 opposite the entry end. All transitions into and out of each module take place within enclosed compartments that house both the conveyor system 22 and the workpieces 11 to be coated.

As best shown in FIG. 1, the conveyor chain 40 is driven by a gearbox and electric motor 76 and conveys workpieces 11 through each of the processes described above. The conveyor chain 40 rolls on the conveyor sprockets 64 that are rotatably supported at fixed locations throughout the apparatus 12. These sprockets 64 maintain chain tightness and provide direction changes defining the conveyor circuit 60. The gearbox and electric motor 76 may be located in a number of suitable locations in the apparatus 12 and preferably nearby one of the many sprockets 64.

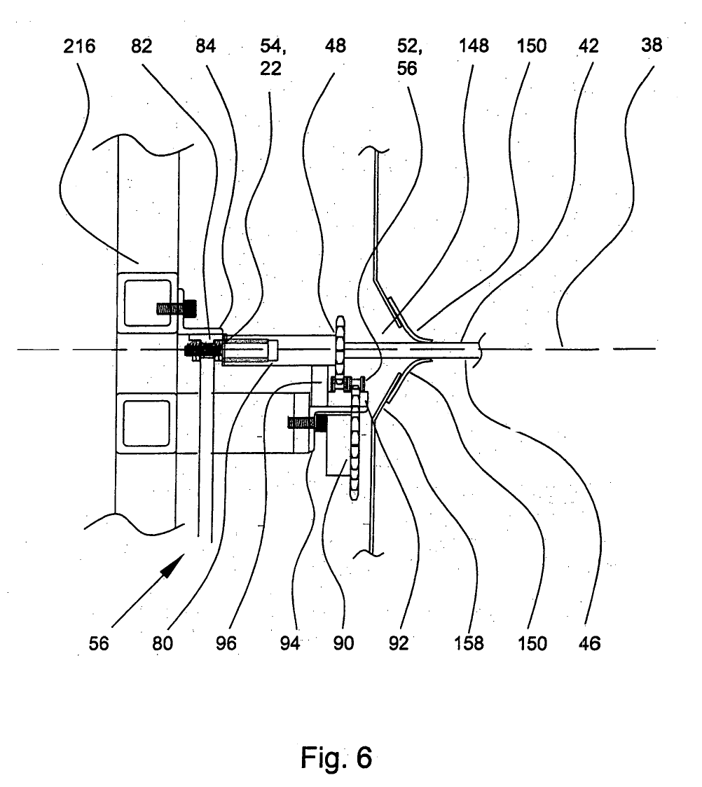

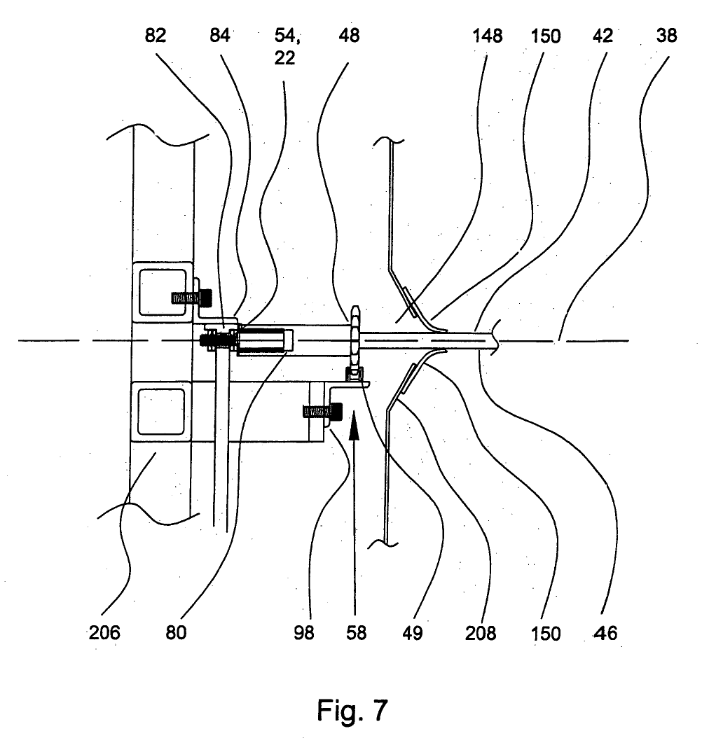

As best shown in FIGS. 6 and 7, the workpiece-mounting racks 42 are rotatably supported at mounting points spaced along the conveyor chain 40 by respective rotating hub assemblies 80. Each rack 42 includes one or more of the workpiece mounts 44 that removably support one or more workpieces 11. The elongated stem 46 of each rack 42 carries workpieces 11 in a cantilevered fashion in respective positions horizontally spaced from the rotating hub assemblies 80 and the conveyor chain 40 along the horizontal rotational axis of the rack 42. This allows the workpieces 11 to be carried through the various washing, drying and coating chambers 18, while protecting the conveyor chain 40 and hub assemblies 80 from contamination. The distance between respective centers of the rotating hub assemblies 80, and therefore between mounting racks 42, may be varied to accommodate a desired manufacturing cycle time and/or workpiece configuration. As shown in FIG. 6, the conveyor chain 40 slides beneath a slide rail 82 mounted to an adjustable bracket 84. This allows the conveyor chain 40 to resist lifting forces placed upon the conveyor chain 40 by the cantilevered weight of the mounting rack 42. This ensures that the workpiece or workpieces 11 being coated will maintain horizontal orientation and a uniform distance from coating applicators 156 of the coating module. In other embodiments any suitable mounting system, such as systems that include chains having extension mounting pins pre-installed on or integral with the chain, may be used in place of the rotating hub assemblies 80.

The purpose of the dynamic rotator system 56 is to rotate each of the workpieces 11 at a controlled adjustable rotational speed while the workpieces are being conveyed through the coating module 32. Within the coating module 32, the dynamic rotator system 56 rotates each workpiece at a controlled rate. The rotator system 56 includes the dynamic rotator chain loop 52, which is driven around a defined circuit by an electric motor powered gearbox 81. The rotator chain loop 52 is supported in a position to engage the hub-mounted sprockets 48 coaxially fixed to each respective workpiece rack 42. When each hub-mounted sprocket 48 is carried to a point where it contacts the dynamic rotator chain 52, the sprocket 48 meshes with the dynamic rotator chain 52 which rotates the rotating hub assembly 80 and the mounting rack 42 as well as any workpieces 11 supported on that rack 42 about the horizontal rotational axis of the workpiece-mounting rack 42. The dynamic rotator chain 52 only engages a hub-mounted sprocket 48 while that sprocket is traveling horizontally through the coating module 32. At an exit end of the coating module 32, the dynamic rotator chain 52 rotates downward on an idler sprocket 90 while the rotating hub assembly 80 remains attached to the conveyor chain 40 thus disengaging the hub-mounted sprocket 48 from the moving rotator chain 52 and eliminating the rotation of the rotating hub assembly 80 and attached workpiece 11. The dynamic rotator chain 52 slides on a top surface of a slide rail 92 mounted to an adjustable bracket 94. A rotating hub support guide 96 made of a low friction material provides a fulcrum necessary to ensure that the cantilevered rack 42 remains in a level horizontal position while traversing the coating module 32. This is accomplished by providing a load-bearing surface to the rotating hub assembly 80 which eliminates any bounce that might otherwise result when the roots of sprocket teeth of the hub-mounted sprocket 48 fall into full engagement with the dynamic rotator chain 52 while rotating.

The purpose of the static rotator system 58 is to positively rotate workpieces 11 through all modules where rotation is necessary but precise control isn't required. The static rotator system 58 includes the lengths of static rotator chain 49, 50, 51. When the hub-mounted sprockets 48 engage the static rotator chain 49, 50, 51 they and their associated mounting racks 42 each rotate at a fixed speed based upon the circumference of the hub-mounted sprocket 48 and the speed of the conveyor chain. Each length of the static rotator chain 49, 50, 51 is secured to an adjustable bracket 98 and provides the fulcrum necessary to ensure that the cantilevered workpiece mounting racks 42 remain in level horizontal attitudes. All horizontal travel of the rack requires either a length of static chain or some other support structure to act as a fulcrum to prevent the racks from sagging. A first static chain 49 of the rotator system 58 is disposed adjacent and parallel to the horizontal portion 60 of the conveyor chain circuit 60 that runs behind the washing and rinsing portion of the washing/drying module 36. The first and lowermost static chain 49 rotates the mounting racks 42 and the workpieces 11 the racks 42 are carrying as they pass through the washing and rinsing portion of the washing/drying module 36. A second static rotator chain 50 is disposed adjacent and parallel to the horizontal portion 66 of the conveyor chain circuit 60 that runs behind the drying chamber 30 in the washing/drying module 36. Three additional lengths of static chain 53 are disposed adjacent and parallel to respective horizontal portions of the conveyor chain circuit 60 that carry racks 42 and workpieces 11 through the curing module 34. The rotation produced by the static chains 53 of the curing module improves coating thickness uniformity. Additionally, lengths of static rotator chain may be supported vertically adjacent vertical portions of the conveyor chain circuit 60 to rotate workpieces 11 as they move from one module to the next.

The washing/drying module 36 is located at the bottom of the stack at ground level and comprises three stages: Stage one which is a washing stage that washes workpieces 11 such as automotive trim workpieces 11 as they enter the coating apparatus 12 and includes the wash chamber 26, stage two which is a recirculated rinse stage that rinses the workpieces 11 after they've been washed and includes a first rinse chamber 100, and stage three which is a second rinsing stage and includes a second rinse chamber 102. The heated drying chamber 30 follows the second rinse chamber 102 of stage three and is disposed atop the wash chamber 26 and the two rinsing chambers 100, 102. The drying chamber 30 dries the workpieces 11 after rinsing. Other embodiments of the coating apparatus 12 may include a washing/drying module 36 having either more or fewer washing and/or rinsing stages.

The washing/drying module 36 also includes a vestibule 104 disposed just upstream from the wash chamber 26 and designed to shield a load/unload station 106 disposed adjacent the wash chamber 26 from any steam or splashing that the washing stage may generate. The vestibule 104 also includes a small exhaust fan that helps to remove any excess steam that might otherwise escape into the load/unload station 106.

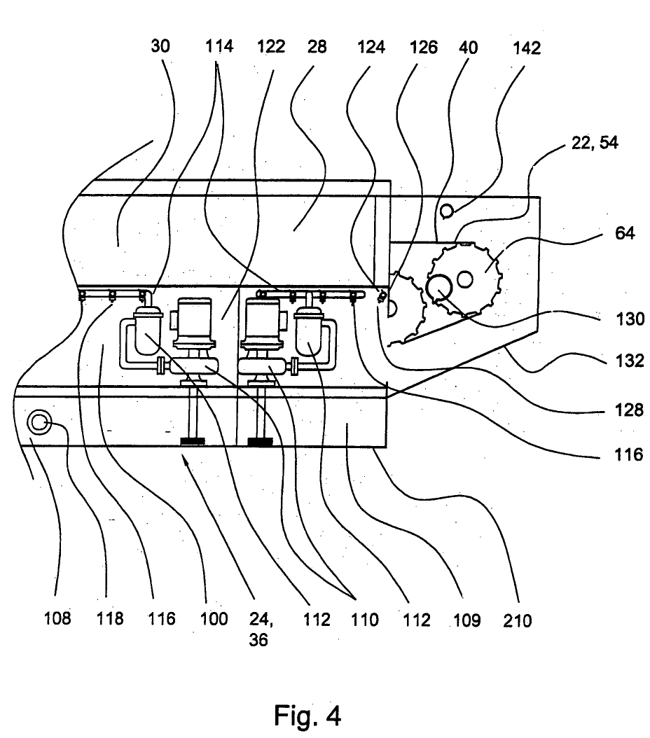

As best shown in FIG. 4, each of the three washing and rinsing stages of the washing/drying module 36 includes its own water storage tank 107, 108, 109, a pressure producing pump 110, an in-line filtration unit 112, distribution piping 114 and high pressure spray nozzles 116. Stage one and two also have immersion heating devices 118 supported within their respective storage tanks 107, 108 which are each capable of generating water temperatures up to 180° F. Water is pumped to each of the three stages from their respective water storage tanks 107, 108, 109. The water is pumped through the respective filtration units 112 and through the respective piped distribution piping 1 into the attached spray nozzles 116. The nozzles 116 direct high-pressure fluid onto the workpiece as they passes through the wash chamber 26 of stage one and the two rinse chambers 100, 102 of stages 2 and 3, respectively. Runoff water falls back into the respective storage tanks 107, 108, 109 for re-use.

In all three stages, the high pressure nozzles 116 are supplied from their associated pumps 110 which receive water from their associated water storage tanks 107, 108, 109 and pump the water from those respective tanks through their associated distribution piping 1 up to their associated high pressure spray nozzles 116. The high-pressure spray nozzles 116 are disposed along a common ceiling of the wash chamber 26 and the two rinse chambers 100, 102 of the washing/drying module 36. The conveyor rotates workpieces 11 as they traverse these chambers 26, 100, 102 of the washing/drying module 36 and cause the workpieces 11 to pass directly below the high-pressure nozzles 116, which are aimed at the workpieces.

In stage one of the washing/drying module 36, the washing or cleaning stage, the nozzles 116 of stage one spray a mild acid or surfactant based chemical or other additive onto workpieces 11 as they pass through the wash chamber 26. This removes foreign material such as petroleum or synthetic based lubricants from workpieces 11 along with dust, dirt, and fibrous materials. Stage one is designed to allow a minimal overflow of the water collected from the washing operation through a weir to facilitate the removal of any floating oils or greases that may accumulate. Overflow water from stage one as well as overflow water from the other two stages is collected in a common capture tank 118 from which the water is pumped to a sanitary drain or other waste fluid disposal system. The stage one wash chamber 26 is approximately 30 inches in length so that a workpiece traveling at 10 inches per minute will take three minutes to pass through. The pass through time may be increased or decreased in other embodiments by increasing or decreasing the speed of the main conveyor chain 40. A ten-inch long first drain area 120 follows the stage one wash chamber 26 and precedes the first rinse chamber 100. The drain area 120 is designed to receive excess water shed from workpieces 11 leaving the stage one wash chamber 26. The first drain area 120 has a sloped floor that allows excess water to drain back into the water storage tank of stage one.

At stage two of the washer 24, the recirculated rinse stage, the nozzles 116 of stage two spray recirculated water onto workpieces 11 as they pass through the first rinse chamber 100. The stage two storage tank 108 water level is maintained by direct supplied make-up or excessive water overflow from the stage three storage tank 109. The first rinse chamber 100 is approximately thirty inches long to provide approximately three minutes of pass-through time for each workpiece 11. A ten-inch long second drain area 122 follows the first rinse chamber 100 of stage 2 and precedes the second rinse chamber 102 of stage 3. As with the first drain area 120 between the stage one wash chamber 26 and the first rinse chamber 100, this second drain area 122 allows each workpiece 11 approximately 60 seconds to shed excess water remaining from the stage two rinse operation. As with the first drain area 120, the second drain area 122 includes a sloped floor to allow excess water to drain back into the stage two water storage tank 108. Excess water accumulation in the stage two storage tank 108 overflows into the common capture tank 118 for disposal into the sanitary drain.

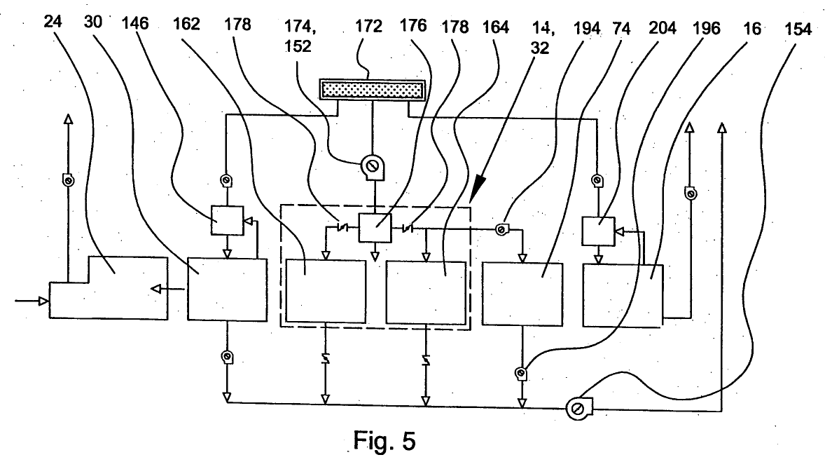

Stage three of the washer 24, the fresh water recirculated rinse stage, includes a fresh water rinse system 124 that provides each workpiece transiting the second rinse chamber 102 with a high pressure rinse followed by a low pressure fresh water rinse. The low-pressure fresh water rinse system 124 includes a known water purifier 125 such as a Reverse Osmosis (R.O.) or De-Ionized (DI) treatment system. As is best shown in FIG. 5, a single pipe header 126 introduces the R.O. or DI water into the second rinse chamber 100 through low-pressure nozzles 128 supported adjacent an exit end of the second rinse chamber 102. The low pressure R.O. or DI nozzles 128 supply the final rinse to the workpieces 11 toward the end of their passage through the second rinse chamber 102 after the higher pressure stage three rinse nozzles 116 have already rinsed the workpieces 11. The low-pressure R.O. or DI nozzles 128 supply the final rinse and provide fresh water make-up flow at from one to four gallons per minute.

Any water overflowing from the stage three storage tank 109 (counter-flowing via a pipe through a common tank wall that separates stage two from stage three) flows into the stage two storage tank 108. Overflow water from the stage two storage tank 108 is drained via an open stage two overflow pipe through an external wall of the stage two storage tank 108 and carries the overflowed water to the common overflow capture tank 118. The stage two overflow pipe is located at a lower elevation than that of a stage three overflow pipe which prevents stage two water from overflowing back to the stage three storage tank 109 by providing a lower operating water level in the stage two tank 108 than in the stage three tank 109. As shown in FIG. 5, stage three also includes a high-pressure compressed air nozzle 130 that receives compressed air from a compressed air source or a blower system and directs it at passing workpieces 11. A drip pan 132 is positioned to collect water blown from workpieces 11 and is sloped back towards the stage three storage tank 109.

As mentioned above, in other embodiments, additional wash stages may be added to the washing/drying module 36 as necessary to conform to customer requirements for various applications. Any additional stages would be added between the wash stage and the second rinse stage and would have specific performance design requirements.

The drying chamber 30 is disposed above the wash and rinse chambers 26, 100, 102 and includes insulated walls 134 having internal and external metallic skins. A structural steel frame 136 is disposed inside the insulated walls 134 and supports the coating and curing modules that are stacked on top of the drying chamber 30. Entrance and exit ends of the chamber have respective openings 138, 140 large enough to allow workpieces 11 and associated mounting racks 42 to pass through. An air blow-off system 142 is disposed adjacent the entrance end of the drying chamber 30 to remove any excess water that may remain on workpieces 11 after they've passed the compressed air nozzle in the second rinse chamber 100. The drying chamber 30 includes a heater and/or dehumidifier 144 that conditions and recirculates drying chamber air to effectively maintain a low humidity environment. An airflow distributor 146 is disposed in the drying chamber 30 to provide high velocity airflow that accelerates the evaporation of any water remaining on passing workpieces 11. An exhaust duct 146 and a fan supported on the drying chamber 30 remove a portion of the recirculating air to maintain an air balance and remove moisture-laden air. The drying chamber 30 is 100 to 150 inches long to provide a 10-15 minute transit or dwell time for each workpiece, but may, in other embodiments, be of any suitable length as may be required to produce a desired pass-through time for a given conveyor chain speed. The drying stage of the washing/drying module 36 is designed to result in workpiece temperatures at the exit end of the drying process that do not exceed 130° F.

A slot 148 extends along and through respective back walls of the three wash/rinse chambers 26, 100, 102 and the drying chamber 30 to provide a path for the horizontally and transversely-oriented elongated stem 46 portions of the workpiece-mounting racks 42 to pass through. The first length static rotator chain 49 can therefore be mounted horizontally and longitudinally along and behind the wash/rinse chambers 26, 100, 102 rather than passing through them. Likewise, the second length of static rotator chain 50 can be supported horizontally and longitudinally along and behind the drying chamber 30 rather than in the drying chamber 30. Sealing strips 150 are disposed in the slot 148 and act as flaps to seal the slot 148 around the workpiece rack stem 46s. The sealing strips 150 are synthetic composition strips in the present embodiment but may comprise any suitable sealing arrangement known in the art.

The coating chamber 18 of the coating module 32 includes two separate cells to allow up to two different types of coatings to be applied to workpieces 11 as they pass through the coating chamber 18. However, other embodiments may include only a single cell or may include more than two cells—depending on the number of coatings to be applied. Providing airflow through the coating module 32 is a supply blower 152 that draws air into the coating module 32 and an exhaust blower 154 that removes air from the module 32. The coating module 32 includes spray applicators 156 for applying coatings to workpieces 11.

The coating module 32 comprises a sheet metal structure that supports coating application equipment and contains any associated overspray. There are two large access doors 160 with safety glass inserts on a front side of the module to provide convenient access to the coating application equipment 156 and to provide process viewing. In embodiments where the coating apparatus 12 is scaled upward to the point where its tall enough to make it hard for an operator to reach coating module access doors 160, a raised platform with steps on either side may be installed. This platform would be mounted above the washer pumps of the washing/drying module 36 and would be able to slide outward to allow access to the pumps and associated filters of the washing/drying module 36 for maintenance. As an option, apparatus 12 could be placed in a pit of adequate size and depth to accommodate the washing/drying module 36 of the coating apparatus 12 and position the coating module 32 at ground level. The opening of the pit surrounding the coating apparatus 12 could then be covered with a floor level plate to facilitate operator access to the coating module access doors 160.

Each of the cells 162, 164 facilitates the application of a different coating, e.g., a primer coat, a basecoat, and/or a clearcoat. A multitude of other commercially applied coatings could also be applied. Each of the individual cells 162, 164 has dedicated controls to assist in balancing air flow and fluid delivery parameters within that specific cell. Between the two cells 162, 164 is an intermediate flash zone 166 where the coated workpiece will have a chance to evaporate or “flash” before having the next layer of coating applied. This intermediate flash is adjustable from three to seven minutes in duration based on atomizer positioning and conveyor chain speed. In each of the cells 162, 164, atomizers can be supported in positions to provide sufficient time to apply two coats of the same substance to each passing workpiece with an adjustable flash time occurring between the coats. This is accomplished by having a first set of atomizers apply a first coat to each workpiece as soon as each workpiece enters the cell. Each workpiece then passes through a space in the cell where no atomizers are present. A second set of atomizers then applies a second coat to each workpiece just before each workpiece exits the cell.

Airflow within the coating module 32 is controlled to provide a laminar profile between supply dispersion media 164 and exhaust overspray capture media 170 thus encompassing the entire spray application envelope. The supply air originates from an external source and is filtered at the point of intake 172. A blower 174 moves the supply air and is capable of producing adequate static pressure. A duct directs the air into a central supply plenum 176. Damper controlled openings 178 disperse pressurized air from the supply plenum into an area above respective spray areas, evenly dispersing the air through the supply filtration/dispersion media 164 above the spray applicators 156. The air is then drawn downward in a laminar profile toward an exhaust plenum 180. The downward flowing air passes by the spray applicators 156 and workpieces 11 being coated at a rate of 50 to 80 feet per minute. Any airborne overspray particulate and volatiles from the coating application are entrained within the airflow with the particulate ultimately being captured by the exhaust filtration overspray capture media 170. The air continues through the overspray capture media into the exhaust plenum 180 from which it flows to the exhaust blower 154 and exhaust duct before finally being released to the atmosphere or into secondary process equipment. The supply control dampers balance the airflow in conjunction with duct dampers located in the duct supplying the exhaust blower.

The applicators 156 are commercially available automatic units that can be of conventional or high volume/low pressure (HVLP) design. The use of air assisted airless, airless, air atomized electrostatic, turbine powered rotary atomizers or any form or combination of the above may be used. The use of small commercially available robots to manipulate the atomizers may also be employed.

The unique aspect of the applicator layout within the coating module 32 allows several applicators 156 to be positioned within a coating cell while only operating one applicator 156 at a time. All of the applicators 156 will apply coatings at some point during a complete cycle. Each applicator 156 is sequenced on and off based upon a trigger signal from a programmable logic controller (PLC) 182 that receives signals from an electronic position sensing device 184 slaved to the conveyor system 22. All applicators 156 have precise fluid delivery control based upon the fact that they are supplied a coating from a commercially available two component mixing/closed loop fluid control delivery system 186.

The closed loop fluid delivery system 186 receives a signal requesting a desired flow rate from the PLC 182 in conjunction with the specific applicator 156 that is being triggered at that time. A fluid delivery supply tube 187 runs serially to each applicator 156. This configuration allows a single two component/closed loop fluid delivery system 186 to effectively supply ten or more applicators 156 within a single cell thus reducing additional equipment requirements for each applicator 156 in use.

The coating material to be sprayed on the workpieces 11 is supplied from storage vessels within a sealed paint storage cabinet or other suitable fluid delivery method. From the storage vessel, the coating is pumped under pressure to the two-component/closed loop fluid delivery system 186. After this, the material is metered to the applicator 156 in use. In conjunction with the coating flow, if there is a need to use a catalyst or hardener, the catalyst material will flow to a second closed loop control device where the catalyst material is introduced and properly mixed with the coating material before being metered to the applicator 156. Additionally, multiple atomizers in one cell can be triggered simultaneously with the addition of more mixing/control equipment if installed.

The applicators 156 are mounted within the coating module 32 using custom made brackets and holders specific to the configuration of workpieces 11 to be sprayed. Fluid and air delivery supply lines 188, 190 are routed within the coating module 32 so as not to interfere with airflow characteristic and workpiece movement. These supply lines are disposed above the respective applicators 156 that they supply. Each applicator 156 has a discreet trigger, atomization, and pattern line originating from a solenoid control panel 191 and terminating at the respective applicator 156.

During its horizontal traverse of the coating module 32, a workpiece 11 will rotate about the horizontally disposed axis of the workpiece-mounting rack 42 that runs along the stem 46 of the rack 42. The rate of rotation is adjustable and is determined by the speed of the main conveyor chain 40 carrying the mounting racks 42 and the speed of the dynamic rotator chain 52 that is horizontally mounted in a position to engage the hub-mounted sprocket 48 of each mounting rack 42 as the racks 42 traverse the coating module 32. As with the static rotator chain 50 in the washing/drying module 36, the dynamic rotator chain 52 is mounted external to and behind the coating chambers 18. The speed of rotation of the dynamic rotator chain 52 is adjusted by the PLC 182 through a Variable Frequency Drive (VFD) 192 and will provide forward or reverse rotation based upon the need of the specific workpieces 11 being coated. The slot 148 extends along respective back walls of the coating cells 162, 164 and the flash zone 166 to provide a path for the workpiece-mounting rack stems 46 to pass through. The sealing strips 150 disposed in the slot 148 seal the slot 148 around the workpiece rack stems 46 against the escape of coating material.

The coating module 32 is lighted using fixtures rated for Class 1, Division 1 locations as specified by the National Electrical Code (NEC) for Hazardous environments. There is a fire suppression system installed within the coating module 32 as required by the National Fire Protection Association (NFPA). Other embodiments may be adapted to conform to whatever fire and safety codes might apply in a given area or industry.

The curing module 34 of the coating apparatus 12 is disposed above and is supported by the coating module 32 and includes a heated curing chamber 20. The curing chamber 20 is heated by recirculated airflow, i.e., convection heating, but may be heated by any other suitable heating system.

The coating apparatus 12 also includes a load/unload station 106 where an operator or feed device is positioned to load workpieces 11 into the coating apparatus 12 and an operator or take-out device is positioned to remove coated workpieces 11 from the coating apparatus 12. In most cases, the coating apparatus 12 is positioned so that the load/unload station 106 is located directly adjacent to an unload station 106 of whatever molding or manufacturing system immediately precedes the coating apparatus 12 in a manufacturing process. In some cases, a single operator may be able to both load and unload the workpieces 11.

The vertically oriented final flash enclosure 74 that covers and provides an enclosed passage between the exit end of the coating module 32 and the entry end of the curing module 34 is sufficiently long to provide an approximate 10 minute transit or dwell time for each workpiece although other embodiments may include flash enclosures of different lengths. Within the final flash enclosure 74 is a final flash system that facilitates the removal of volatiles that evaporate or “flash” from the coating applied in the final coating cell. The final flash enclosure 74 enclosure is of size adequate to allow the workpieces 11 to traverse through without any interference from sidewalls. The final flash enclosure 74 protects coated workpieces 11 from external ambient conditions such as dirt and dust and allows a frequent changeover of air within the enclosure. This facilitates the removal of volatiles that may accumulate in the enclosure. A small supply fan 194 supported at the top of the enclosure and a second exhaust fan 196 at the bottom of the enclosure passes air through the final flash enclosure 74 to remove solvent laden air and to exhaust such air to the atmosphere. In other embodiments, any suitable means of supplying and/or exhausting air may be employed.

The final flash enclosure 74 is of metallic structure and is hinged on one side to allow for opening of the enclosure for maintenance. During workpiece transfer activity the enclosure remains closed. There is a seal around the perimeter of the enclosure that is compressed when the enclosure is closed thus improving separation of the enclosed area from any ambient contamination. There is a small access door 198 on one side of the enclosure that has a sealed safety glass insert. The access door 198 allows process viewing and enables workpiece removal for coating application inspection.

The curing module 34 comprises a metallic integral structure that includes the external walls 134 defining the curing chamber 20. Between the walls 134, there is an insulation material rated for high temperature applications. The curing module 34 is stacked on the top of the coating module 32 and is elevated above the other modules 34, 36.

The curing chamber 20 encloses an open heated space large enough to ensure that workpieces 11 passing through the curing module 34 do not contact the walls 134 of the module or interfere with each other's path. Within the curing module 34 there is a series of duct openings 202 designed to move air within the heated space. The air is circulated and recirculated through ductwork leading to and from the openings 202 to ensure uniform heating of the space. An infrared or in-line electric or gas heating unit 204 is used to control the temperature within the module 34. In other embodiments, other known heating technologies can be employed as appropriate to meet process requirements. The operating temperature is between 160-450° F., depending on workpiece and coating requirements. Because of heat loss concerns, the main conveyor system 22 is internal to the curing module 34 rather than being positioned behind it. The upper static rotator chain 51 is also supported within the chamber 20.

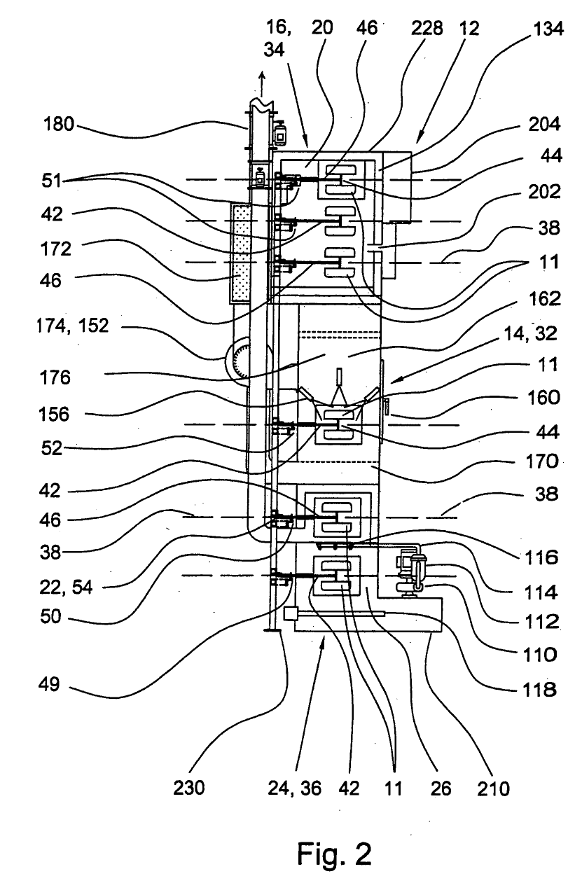

The three modules 32, 34, 36 are designed to include all components necessary to operate the coating apparatus 12 once the three modules have been stacked in the proper order. As best shown in FIGS. 2, 10 and 11, the conveyor system 22 structure is incorporated into the respective structures of the module chambers and is, consequently dividable into three portions—each portion being associated with one of the modules 32, 34, 36. In other words, the three portions of the conveyor system 22 are integral components of the three modules 32, 34, 36 to promote ease of disassembly, transport and re-assembly.

The lower module, the washing/drying module 36, includes a structural support steel frame 206 enclosed by heavy gage sheet metal panels 208 and incorporates a related portion of the conveyor system 22. A flat base wall 210 of the module, defined by the steel frame and a sheet metal base panel, is set upon a level floor. The heavy gage sheet metal panels fastened to the structural steel frame both encloses and enhances the structural integrity of the washing/drying module 36. The structural steel frame 206 and the sheet metal panels 208 cooperate to provide sufficient support for both the washing/drying module 36 itself and modules 32, 34 stacked on top of it. A top wall 212 of the washing/drying module 36 defined by the structural steel frame and a top sheet metal panel provides a flat surface that the coating module 32 is set upon and bolted to.

A flat base wall 214 of the coating module 32 is similarly defined by a structural steel frame 216 of the coating module 32 and a base sheet metal panel 218 and is constructed to rest upon the top wall 212 of the washing/drying module 36. As with the washing/drying module 36 the coating module 32 comprises the structural steel frame 216 enclosed by sheet metal panels 218 and further includes related conveyor components. A top wall 220 of the coating module 32 is defined by a top panel of heavy gage sheet metal supported on the structural steel frame 216 and provides a flat surface that the curing module 34 is supported on and bolted to.

The curing module 34 also comprises sheet metal panels 222 enclosing a structural steel frame 224 and includes all related conveyor system 22 components. A base wall 226 of the curing module 34 is designed to rest on and to be bolted to the top wall 220 of the coating module 32. A top wall 228 of the curing module 34 includes a top sheet metal panel supported on the structural steel frame 224.

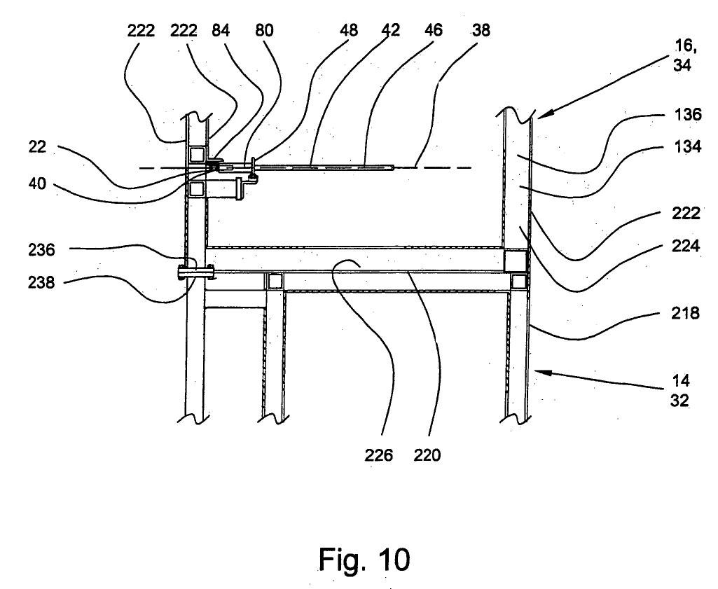

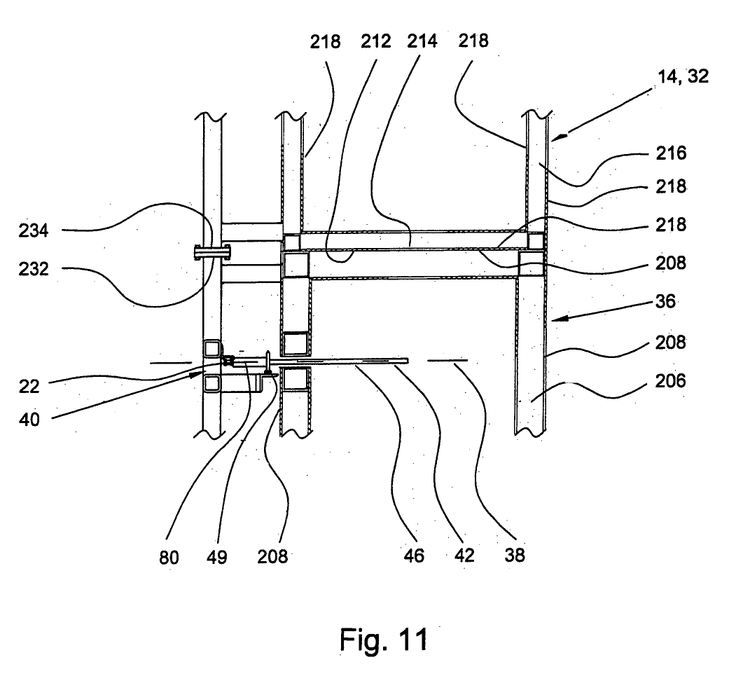

As shown in FIG. 2, the portion of the conveyor system 22 associated with the washing/drying module 36 (and that is affixed to and included in the washing/drying module 36) includes support plates 230 supported at a floor level of the module 36 and, as best shown in FIG. 11, top attachment plates 232 supported at a top level of the module. The portion of the conveyor system 22 affixed to and included in the coating module 32 has lower attachment plates 234 that line up with the top attachment plates 232 of the washing/drying module 36 when the coating module 32 is set in place on the washing/drying module 36. As best shown in FIG. 10, the portion of the conveyor system 22 structure affixed to and included in the curing module 34 has lower attachment plates 236 that line up with top attachment plates 238 of the coating module 32 when the curing module 34 is set in place on the coating module 32.

Each of the modules 32, 34, 36 is designed to be moved and stacked with a forklift or an overhead crane. Temporary lifting lugs can be attached to any of the modules using four boltholes that are designed into the structural steel framework of each module.

In practice, a coating can be applied to each of a plurality of workpieces 11 using a coating apparatus 12 comprising a coating system 14 that coats workpieces 11 and that includes a coating chamber 18 that receives workpieces 11 for coating, a curing system 16 that cures coatings that the coating system 14 has applied to workpieces 11 and that includes a curing chamber 20 that receives workpieces 11 for curing, the coating chamber 18 and curing chamber 20 being disposed in a stacked arrangement. A coating can be applied to each of a plurality of workpieces 11 using such an apparatus 12 by transporting each workpiece along a vertically oriented circuit 60 such that each workpiece passes first through the coating chamber 18 and then through the curing chamber 20. One or more coatings are deposited on each workpiece as each workpiece passes through the coating chamber 18. Each workpiece is supported on a continuous drive chain supported to carry the workpieces 11 around the circuit 60. Each workpiece is rotated about a horizontal axis as a coating is deposited on each workpiece and is also rotated about a horizontal axis after a coating has been deposited on the workpiece and before the coating has hardened.

Where a coating apparatus 12 additionally includes a washer 24 that washes and rinses workpieces 11 and that includes a wash chamber 26 that the workpieces 11 pass through as they're washed, and where that coating apparatus 12 additionally includes a drier 28 that dries workpieces 11 after they've been washed and rinsed and that includes a drying chamber 30 that the workpieces 11 pass through as they're dried, the workpieces 11 are transported along a vertically oriented circuit 60 such that each workpiece passes first through the wash chamber 26, then through the drying chamber 30 and then through the coating chamber 18 and the curing chamber 20. Each workpiece is rotated about a horizontal axis as each workpiece is washed and rinsed while passing through the washing and rinsing chambers.

A more detailed description of this process follows:

The process of coating a plurality of workpieces 11 using the coating apparatus 12 begins by designing and fabricating a series of workpiece racks 42 and connecting them at spaced-apart positions along the main conveyor chain 40. The racks 42 are designed to correspond to the configuration or configurations of the workpieces 11 and are capable of supporting the workpieces 11 through the various attitude changes they will be subjected to in the process of being cleaned, dried, coated and cured. Generally each rack 42 is designed to carry two or more workpieces 11. After the workpiece racks 42 have been fabricated and the workpieces 11 have been formed, trimmed, inspected for defects and have otherwise completed pre-coating processing, a person loads the workpieces 11 by supporting them on the specially-designed workpiece racks 42 and ensuring that the workpieces 11 are properly secured on the racks 42. The main conveyor chain 40 moves the workpiece racks 42 at a slow rate that accommodates the loading of the racks 42. Where two or more workpieces 11 are to be loaded on a single rack 42, the operator repeats the loading process for each additional workpiece after having rotated or indexed the rack about its stem 46 to present an empty workpiece-carrying position.

The speed of the moving racks 42 is synchronized with a cycle rate of the manufacturing process that is supplying the workpieces 11 to the coating apparatus 12 and/or to a manufacturing process that the coating apparatus 12 is supplying the workpieces 11 to. The rack speed also provides ample time for operators to perform the loading function. This system can, alternatively, be used in a “stand alone” fashion independent of requirements imposed by preceding or subsequent process limitations. As such, in a stand-alone mode, the coating apparatus may be operated at higher speeds with consequent increased throughput.

After the uncoated workpieces 11 are loaded on a rack, the operator removes the painted workpieces 11 from a preceding rack disposed upstream from the newly loaded rack 42. The painted workpieces 11 that the operator has removed are then visually inspected for appearance quality and, if conforming, are either transferred to a subsequent manufacturing process or are properly labeled, packaged and prepared for shipment to a storage location. Non-conforming workpieces 11 are placed into a special container separate from conforming workpieces 11. In some applications, it may become necessary to divide the workload among two individuals to ensure proper processing and inspection time.

After being loaded on racks 42, the workpieces 11 enter the first stage wash chamber of the washing/drying module 36 after first passing through the vestibule 104. The racks 42 carry the workpieces 11 horizontally through the wash and rinse chambers while rotating them about the rack stems 46. Water is pumped from the recirculated storage tank, through the filtration systems and piped distribution systems and spray nozzles of each of the three stages. The nozzles direct the high-pressure water towards the transiting, rotating workpieces 11 to clean and rinse all exposed surface of the workpieces 11. The runoff water falls into the respective holding tanks for re-use. Each rack 42 takes approximately three minutes to transit the first stage wash chamber, 60 seconds to transit the first drain area, three minutes to transit the second stage chamber, 60 seconds to transit the second drain area and three minutes to transit the third stage chamber. After exiting the third stage chamber the workpieces 11 are immediately blown off with high-pressure air.

After the workpiece has been washed, rinsed, and blown-off, the workpiece turns upward thorough a 180° and enters the drying chamber 30. In the drying chamber 30 the workpieces 11 are rotated by the racks 42 as the travel horizontally above the path they followed through the washer 24 stages. As the workpieces 11 enter the drying chamber 30 the air blow off system removes any water remaining on the workpiece surfaces. For 10 to 15 minutes the workpieces 11 will continue to transit the drying chamber 30 as dehumidified and/or heated air circulates about them.

After exiting the drying chamber 30 the workpieces 11 turn upward 90° and travel vertically a short distance before making another 90° turn to head horizontally into the coating module 32 along a path disposed above and opposite the path they followed through the drying chamber 30, below. The two turns and horizontal travel will provide additional time for the workpieces 11 to cool and stabilize in temperature before entering the coating module 32.

The workpieces 11 then move horizontally through the two coating cells 162, 164 and the flash zone 166 disposed between the cells 162, 164 in the coating module 32. In the first cell 162, a first coating, such as a primer or base coat, is applied to each workpiece. In the flash zone 166, the first coating is at least partially dried onto each workpiece. In the second cell 164 a second coating, such as a clearcoat is applied.

As the workpieces 11 move into the first coating cell 162 the hub-mounted sprocket 48 of each mounting bracket engages a portion of the dynamic rotator chain 52 that runs behind and along the coating cells 162, 164 and the flash zone 166. The speed of the longitudinal motion of the bracket and the speed of the dynamic rotator chain 52 and the diameter of the hub-mounted sprocket 48 together determine the speed at which the workpieces 11 rotate around the stem 46s of the brackets supporting them as they traverse the coating module 32.

Immediately after coated workpieces 11 exit the coating module 32, they enter the final flash enclosure 74. Once within the enclosure the workpieces 11 turn upward 90° and travel vertically to an upper end of the final flash enclosure 74.

From the upper end of the final flash enclosure 74 the workpieces 11 turn 90° and traverse through the curing module 34 horizontally except when changing directions 180° to head horizontally in the opposite direction. The workpieces 11 enter the module near the top of one of two end walls adjacent to the final flash enclosure 74. Shortly after entering, the hub-mounted sprocket 48 of each mounting bracket engages the static rotator chain 51 that runs parallel and adjacent to the conveyor chain through the curing chamber. The fixed rate of rotation is determined by the speed of the conveyor chain 40 that carries the mounting racks 42 and the diameters of the hub-mounted sprockets 48 of the racks 42 that engage the static rotator chain 50 located internally to the curing module 34. The workpieces 11 rotate as they serpentine through the curing chamber 20 from top to bottom with the major travel being on the horizontal plane. The workpieces 11 exit the curing module 34 directly above the load/unload station 106 opposite the side of entry. In most cases, the workpieces 11 will exit from the bottom floor of the curing module 34 to minimize heat loss through the exit.

The Programmable Logic Controller (PLC) 182 controls all functional aspects of the coating apparatus 12. An operator initiates workpiece style and color change parameters along with process and fault annunciation monitoring from a remote flat screen display or other interface device 191. The PLC 182 controls the speed of the conveyor chain 40 and the dynamic rotator chain with an analog output signal sent to respective Variable Frequency Drives (VFDs) 192, 242 that provide drive power to the respective chain drive motors 76, 81. Conveyor chain position and job tracking signals are provided to the PLC 182 from the slaved sensing device 184 on the conveyor chain 40. The slaved sensing device 184 may be an encoder, resolver or proximity switch depending on conveyor type and workpiece configuration.

The pumps are started with contactor type motor starters that are energized from a PLC output. There are pressure switches on each pump with inputs back to the PLC 182 for fault annunciation. A fault from the pump pressure switches will indicate a failed pump or plugged filter element. Temperature monitoring is provided by temperature controllers. The temperature controllers monitor and control the temperatures of the heated wash stages, the drying chamber 30 and the curing chamber 20. These controllers operate independent of the PLC 182. However, an analog signal is provided from the temperature controllers to the PLC 182 for temperature data logging and fault monitoring. The temperature fault monitoring process will include a temperature-operating window within the PLC 182, and any drops or increases in temperature outside of the predetermined window will annunciate a fault condition to the operator.

Airflow monitoring by the PLC 182 will occur with the use of pressure differential switches mounted at critical points in the process. Pressure differential switches with analog outputs are mounted at all filtration points to monitor filter media condition. As filters begin to load up with captured particulate, the pressure differential across that filter increases. The increase in pressure drop modifies the analog signal input to the PLC 182. The PLC has a predetermined operating window for the respective signal and annunciates a fault condition when pressure drop values fall or increase outside of a predetermined window.

The primary PLC function is to control the coating application parameters and related equipment. The PLC 182 stores and controls all coating process parameters. The PLC 182 provides a variable analog or digital output to pressure transducers 250 for the proportional control of air pressure required for atomization and pattern control for each applicator 156. A minimum of two transducers 250 are used for each coating cell within the coating module. The transducer 250 is shared by all applicators 156 within a cell by providing the proper air pressure to a solenoid manifold within the solenoid control panel 191. The manifold diverts airflow to a specific applicator 156 based upon an output signal from the PLC 182 to the respective solenoid. Concurrent with the output signal to the atomization and pattern solenoid, the PLC 182 provides an analog or digital signal to the respective transducers 250 to adjust air pressure as necessary for the respective applicator 156. The atomization or pattern solenoid signal is timed against the applicator trigger signal from the PLC 182 to provide atomization and pattern delay as necessary. This delays the trigger “on” signal until after the atomization and pattern signal has been established at the beginning of an applicator spray cycle. At the end of the applicator spray cycle, the trigger signal will turn off before atomization and pattern signals are disabled. After the applicator spray cycle is complete, the next applicator 156 in the sequence actuates. This continues until all applicators 156 have been triggered to complete a sequence cycle matched to the cycle time duration of the manufacturing cycle that is supplying the workpiece.

Concurrent with the above activity, the PLC 182 also sends an analog or digital signal to the commercially available two-component closed loop fluid delivery system 186 to adjust the fluid flow rate for the applicator 156 in use. An interface with the fluid delivery system 186 is as specified by the manufacturer. System fault outputs from the fluid delivery system interface with the PLC 182 to annunciate fault conditions to the operator. Fluid is supplied to the fluid delivery system 186 from a remotely located paint storage/pumping cabinet 252. The PLC 182 interfaces with the solenoid control panel 191 from which a pilot signal is sent to the paint storage cabinet control valves to stop paint flow or to initiate color change processes. In other embodiments, color valves may be mounted with and incorporated into the fluid delivery/metering equipment.

Vertical stacking reduces floorspace requirements so dramatically that a plurality of coating apparatuses 12 can be employed in an array to increase throughput while enhancing manufacturing flexibility. Flexibility is enhanced because this coating system 14 can be easily integrated with and positioned next to other manufacturing operations that either produce workpieces to be coated or receive coated workpieces from the coating apparatus for further manufacturing operations. Additionally, each coating apparatus 12 can be configured differently to handle different workpieces 11 or to apply different coatings.

A coating apparatus 12 constructed as described above is readily integratable with existing manufacturing processes that precede and/or follow coating application. So integrated, the apparatus 12 can use labor resources that are already required to operate the existing process or processes and eliminate labor required to operate coating operations.

If, for example, the present coating apparatus 12 is integrated to directly follow a molding operation and is immediately followed by an assembly operation, the molding machine operator could load workpieces 11 onto the coating apparatus 12 and the assembly operator could unload coated workpieces 11 from the coating apparatus 12. The molding machine operator could load each workpiece 11 in approximately the same time that it would have taken him to accomplish his former task of wrapping and boxing the workpiece. The assembly operator could unload the painted workpieces from the apparatus 12 in about the same time it would have taken him to accomplish his former task of removing a painted workpiece from a packing crate or box. Coating apparatus 12 incorporation therefore reduces labor costs because it uses existing molding and assembly operation labor resources and obviates the need for additional labor assigned to handle existing coating application processes.

Inserting the present coating apparatus 12 into an existing manufacturing process also reduces in process inventory (the typical inventory of workpieces 11 typically found between molding and paint or paint and assembly). Having incorporated the present coating apparatus 12, there would be no need for storing raw molded workpieces before painting them and no need for storing workpieces after painting and before assembly. The present coating apparatus 12 provides a finished part that can be inventoried one time (finished goods). This can dramatically improve inventory turns in a manufacturing facility.

Integration of an array of the coating apparatuses 12 into a manufacturing process adds considerable flexibility to the process by allowing workpieces 11 to be routed from a molding operation, for example, to different coating apparatuses 12 in the array to have different coatings applied. The use of an array can minimize the impact of downtime for maintenance, repair or reconfiguration since the remaining units can continue operating while one coating apparatus 12 at a time is shut down. The modular construction of the coating apparatus 12 further enhances manufacturing flexibility by allowing the coating apparatus 12 to be easily and quickly disassembled, transported from one position to another and reassembled. Its small footprint allows it to be assembled in small spaces adjacent the output and/or input areas of existing processes.

Rotation of the workpieces 11 about horizontal axes 38 prevents runs and other coating thickness irregularities that typically result from the effects of gravity on the coating when it has just been applied to a workpiece 11 and is still uncured. As such, thicker coatings may be applied by the present coating apparatus 12 without risking runs and sags. Rotation of the workpieces 11 through the washing and rinsing chambers enhances the removal of excess water during washing and rinsing. The cantilevered arrangement of the workpiece racks 42 allows the workpieces 11 to be carried through the various washing, rinsing, drying and coating chambers while protecting the conveyor chain 40 and hub assemblies from contamination.

This description is intended to illustrate certain embodiments of the invention rather than to limit the invention. Therefore, it uses descriptive rather than limiting words. Obviously, it's possible to modify this invention from what the description teaches. Within the scope of the claims, one may practice the invention other than as described.

What is claimed is:

1. A workpiece coating apparatus (12) for applying a coating to each of a plurality of workpieces (11), the apparatus (12) comprising:
a coating system (14) configured to coat workpieces (11) and including a coating chamber (18) configured to receive workpieces (11) for coating;
a curing system (16) configured to cure coatings that the coating system (14) has applied to workpieces (11), the curing system (16) including a curing chamber (20) configured to receive workpieces (11) for curing;
a conveyor system (22) configured to serially transport workpieces (11) first through the coating chamber (18) and then through the curing chamber (20); and
the coating chamber (18) and curing chamber (20) being disposed in a stacked arrangement to minimize floor space requirements.

2. A workpiece coating apparatus (12) as defined in claim 1 in which the coating apparatus (12) includes:
a washer (24) configured to wash workpieces (11), the washer (24) including a wash chamber (26) that the workpieces (11) pass through as they're washed; and
a drier (28) configured to dry workpieces (11) after they've been washed, the drier (28) including a drying chamber (30) configured to receive the workpieces (11) for drying, the conveyor system (22) being configured to serially transport workpieces (11) first through the wash chamber (26), then through the drying chamber (30) and then through the coating chamber (18) and the curing chamber (20).

3. A workpiece coating apparatus (12) as defined in claim 2 in which the wash chamber (26) and drying chamber (30) are disposed in a stacked arrangement with the coating chamber (18) and the curing chamber (20).

4. A workpiece coating apparatus (12) as defined in claim 3 in which the curing chamber (20) is disposed above the coating chamber (18).

5. A workpiece coating apparatus (12) as defined in claim 4 in which the coating chamber (18) is disposed above the washing and drying chambers (30).

6. A workpiece coating apparatus (12) as defined in claim 5 in which the drying chamber (30) is disposed above the wash chamber (26).

7. A workpiece coating apparatus (12) as defined in claim 2 in which the coating apparatus (12) includes a coating module (32) comprising the coating chamber (18) and a curing module (34) including the curing chamber (20), the curing module (34) being removably attached to the coating chamber (18).

8. A workpiece coating apparatus (12) as defined in claim 7 in which the coating apparatus (12) includes a washing/drying module (36) comprising the wash chamber (26) and the drying chamber (30), the coating module (32) being removably attached to the washing/drying module (36).

9. A workpiece coating apparatus (12) as defined in claim 8 in which the conveyor system (22) is configured to rotate the workpieces (11) about horizontal axes (38) while transporting the workpieces (11) serially through the coating module (32) and the curing module (34).

10. A workpiece coating apparatus (12) for applying a coating to each of a plurality of workpieces (11), the apparatus (12) comprising:
a coating system (14) configured to coat workpieces (11) and including a coating chamber (18) configured to receive workpieces (11) for coating;
a curing system (16) configured to cure coatings that the coating system (14) has applied to workpieces (11), the curing system (16) including a curing chamber (20) configured to receive workpieces (11) for curing;
a conveyor system (22) configured to serially transport workpieces (11) first through the coating chamber (18) and then through the curing chamber (20);
the conveyor system (22) is configured to rotate the workpieces (11) about horizontal axes (38) while transporting the workpieces (11) serially through at least one of the coating module (32) and the curing module (34); and
the conveyor system (22) includes:
hub-mounted sprockets (48) that each support a workpiece (11) for rotation about their respective horizontal axes (38); and
a static rotator chain (50) mounted in a position to engage the hub-mounted sprockets (48) and to cause the hub-mounted sprockets (48) and supported workpieces (11) to rotate about their respective horizontal rotational axes (38).

11. A workpiece coating apparatus (12) for applying a coating to each of a plurality of workpieces (11), the apparatus (12) comprising:
a coating system (14) configured to coat workpieces (11) and including a coating chamber (18) configured to receive workpieces (11) for coating;
a curing system (16) configured to cure coatings that the coating system (14) has applied to workpieces (11), the curing system (16) including a curing chamber (20) configured to receive workpieces (11) for curing;
a conveyor system (22) configured to serially transport workpieces (11) first through the coating chamber (18) and then through the curing chamber (20), the conveyor system (22) being configured to rotate the workpieces (11) about horizontal axes (38) while transporting the workpieces (11) serially through at least one of the coating module (32) and the curing module (34);
the coating chamber (18) and curing chamber (20) being disposed in a stacked arrangement.

12. A workpiece coating apparatus (12) as defined in claim 11 in which the conveyor system (22) includes:
a conveyor chain (40) that is routed sequentially through the coating module (32) and the curing module (34); and
a plurality of workpiece racks (42) supported for rotation about respective horizontal rotational axes (38) that extend perpendicularly from the conveyor chain (40), the racks (42) being supported at spaced locations along the conveyor chain (40), each rack (42) including one or more workpiece mounts configured to removably support one or more workpieces (11).

13. A workpiece coating apparatus (12) as defined in claim 12 in which each workpiece rack (42) includes an elongated stem 46 that horizontally spaces the workpiece mounts from the conveyor chain (40) along the horizontal rotational axis of the rack (42).

14. A workpiece coating apparatus (12) as defined in claim 13 in which the conveyor system (22) includes:
hub-mounted sprockets (48) coaxially fixed to each respective workpiece rack (42); and
a static rotator chain (50) mounted in a position to engage the hub-mounted sprockets (48) and to cause the hub-mounted sprockets (48) and attached workpiece racks (42) to rotate about their respective horizontal rotational axes (38).

15. A workpiece coating apparatus (12) as defined in claim 14 in which the conveyor system (22) includes a dynamic rotator chain loop (52) that's supported to be driven around a defined circuit (60) and is supported in a position to engage the hub-mounted sprockets (48) supporting the workpiece mounting racks (42) on the conveyor chain (40) as the conveyor chain (40) carries the racks (42) along the conveyor chain circuit (60) such that the sprockets mesh with the dynamic rotator chain (52) and rotate the mounting racks (42) about the horizontal rotational axis of the workpiece-mounting rack (42).

16. A method for applying a coating to each of a plurality of workpieces (11) includes:
providing a coating apparatus (12) comprising a coating system (14) configured to coat workpieces (11) and including a coating chamber (18) configured to receive workpieces (11) for coating, a curing system (16) configured to cure coatings that the coating system (14) has applied to workpieces (11), the curing system (16) including a curing chamber (20) configured to receive workpieces (11) for curing, the coating chamber (18) and curing chamber (20) being disposed in a stacked arrangement, the method including the steps of:
transporting each workpiece (11) along a vertically oriented circuit (60) such that each workpiece (11) passes first through the coating chamber (18) and then through the curing chamber (20);
depositing a coating on each workpiece (11) as it passes through the coating chamber (18); and
rotating each workpiece (11) about a horizontal axis as coating is deposited on each workpiece (11).

17. The method of claim 16 in which:
the step of providing a coating apparatus (12) includes providing a coating apparatus additionally including a washer (24) that washes and rinses workpieces (11), the washer including a wash chamber (26) that the workpieces pass through as they're washed; and a drier (28) that dries workpieces after they've been washed and rinsed, the drier including a drying chamber (30) that the workpieces pass through as they're dried,
the transporting step includes transporting each workpiece along a vertically oriented circuit (60) such that each workpiece (11) passes first through the wash chamber (26), then through the drying chamber (30) and then through the coating chamber (18) and the curing chamber (20); and
including the additional step of rotating each workpiece (11) about a horizontal axis as it is washed and rinsed while passing through the washing and rinsing chambers.

18. The method of claim 16 in which the step of transporting each workpiece (11) along a vertically oriented circuit (60) includes supporting each workpiece (11) on a continuous drive chain supported to carry each workpiece (11) around the circuit (60).

19. The method of claim 16 in which the step of rotating each workpiece (11) about a horizontal axis includes rotating each workpiece (11) about a horizontal axis after a coating has been deposited on each workpiece (11) and before the coating has hardened.

20. The method of claim 16 in which the step of providing the coating apparatus (12) includes providing the coating apparatus at an output area of a workpiece producing process.

21. The method of claim 20 in which, preceding the transporting step, an operator of the workpiece producing process removes workpieces from the workpiece producing process and loads them onto the coating apparatus for coating.

22. The method of claim 16 in which the step of providing the coating apparatus (12) includes providing the coating apparatus at an input area of a process using coated workpieces.

23. The method of claim 22 in which, following the depositing step, an operator of the process using coated workpieces removes coated workpieces from the coating apparatus (12) and inputs them into the process using coated workpieces.
